(19) United States
(12) Patent Application Publication
(10) Pub. No.: US 2003/0160362 A1
(43) Pub. Date: Aug. 28, 2003

(54) Method of injection molding an article having an array of openings

(75) Inventor: Paul Charles Fithian, Michigan City, IN (US)

Correspondence Address: TAROLLI, SUNDHEIM, COVELL,, TUMMINO & SZABO L.L.P., 1111 LEADER BUILDING, CLEVELAND, OH, 44114, US

(73) Assignee: Lighthouse Industries, Inc.

(21) Appl. No.: 10/080,852

(22) Filed: Feb. 22, 2002

(51) Int. Cl. B29C 45/00

(52) U.S. Cl. 264/328.12; 264/334; 425/542

(57) ABSTRACT

A mold assembly for injection molding an article includes a first mold part having a first inner surface of the mold having a configuration corresponding to the configuration of the first surface of the article. A first array of first pins extends from the first inner surface through the mold cavity when the mold assembly is closed. A second mold part has a second inner surface of the mold having a configuration corresponding to the configuration of the second surface of the article. The second mold part has a second array of second pins extending from the second inner surface and only partially into the mold cavity. The article is preferably molded with a low viscosity, high temperature material, such as a liquid crystal polymer.

### BACKGROUND OF THE INVENTION

The present invention relates to a method of injection molding an article having an array of openings. In particular, the present invention relates to a method of injection molding a template for use in radiation therapy. The present invention is applicable to the molding of other types of articles.

U.S. Pat. Nos. 6,129,670 and 6,256,529 describe a real time brachytherapy spatial registration and visualization system. The system is used to implant radioactive seeds into a human organ, such as a prostate gland. The system uses an “implant template”, which is a plastic rectangle, or block, containing an array of very small diameter needled openings separated at fixed intervals. Needles are inserted into the gland through the needle openings in the template, to implant seeds into the gland. The needle openings in the template are precisely positioned so that the seeds can be placed in desired locations. in the template are precisely positioned so that the seeds can be placed in desired locations.

The template is difficult to clean because of the presence of the large number of small diameter needle openings. Therefore, it would be desirable to make the template a disposable, single-use item. However, because the needle openings are drilled in the template, a relatively expensive process, the template is expensive. As a result, the template is typically cleaned and reused, rather than discarded.

### SUMMARY OF THE INVENTION

The present invention is a method of injection molding an article having first and second surfaces on opposite sides of the article, a first array of first openings that extend completely through the article between the first and second surfaces, and a second array of second openings that extend only partially through the article from the second surface in a direction toward the first surface and that are interspersed with first openings of the first array. The comprises the steps of:

providing a mold defining a mold cavity having a configuration corresponding to the configuration of the article, the mold having a first array of first pins extending through the mold cavity between first and second inner surfaces of the mold having a configuration corresponding to the configuration of the first and second surfaces of the article, the mold also having a second array of second pins extending only partially through the mold cavity from the second inner mold surface in a direction toward the first inner mold surface; and

conducting a flow of molten material into the mold cavity when the mold is in a closed condition to flow around the first pins to form the first openings in the article and to flow around the second pins to form the second openings in the article.

The present invention is also a mold assembly for injection molding an article having first and second surfaces on opposite sides of the article, a first array of pin openings that extend completely through the article between the first and second surfaces, and a second array of core openings that extend only partially through the article from the second surface in a direction toward the first surface and that are interspersed with pin openings of the first array. The mold assembly comprises a first mold part and a second mold part movable between an open condition of the mold assembly and a closed condition of the mold assembly, the first and second mold parts defining a mold cavity having a configuration corresponding to the configuration of the article. The first mold part has a first inner surface of the mold having a configuration corresponding to the configuration of the first surface of the article. The first mold part has a first array of first pins extending from the first inner surface through the mold cavity when the mold assembly is in the closed condition. The second mold part has a second inner surface of the mold having a configuration corresponding to the configuration of the second surface of the article. The second mold part has a second array of second pins extending from the second inner surface and only partially into the mold cavity.

### BRIEF DESCRIPTION OF THE DRAWINGS

The foregoing and other features of the invention will become apparent to one skilled in the art to which the invention relates upon consideration of the following description of the invention with reference to the accompanying drawings, in which:

FIG. 1 is a front perspective view of an article that is made by a process and mold assembly in accordance with the invention;

FIG. 2 is a front elevational view of the article of FIG. 1;

FIG. 3 is a rear elevational view of the article of FIG. 1;

FIG. 4 is a partial sectional view of the article of FIG. 1, taken along line 4-4 of FIG. 3;

FIG. 5 is an enlarged view of a portion of FIG. 3;

FIG. 6 is a view of a mold assembly for molding the article of FIG. 1 and used in the process of the invention, the mold being shown in a closed condition;

FIG. 7 is a view similar to FIG. 6 showing the mold in an open condition, with an article molded and ready to be ejected;

FIG. 8 is a view similar to FIG. 7 showing the article being ejected; and

FIG. 9 is an enlarged view of a portion of FIG. 8.

### DESCRIPTION OF THE INVENTION

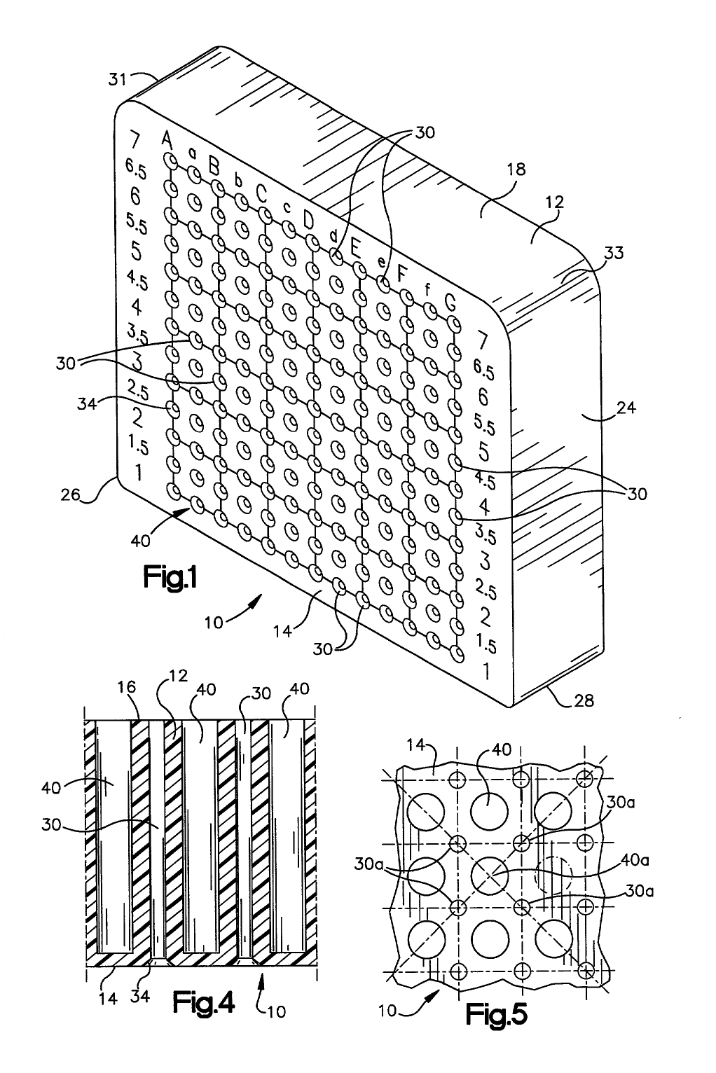

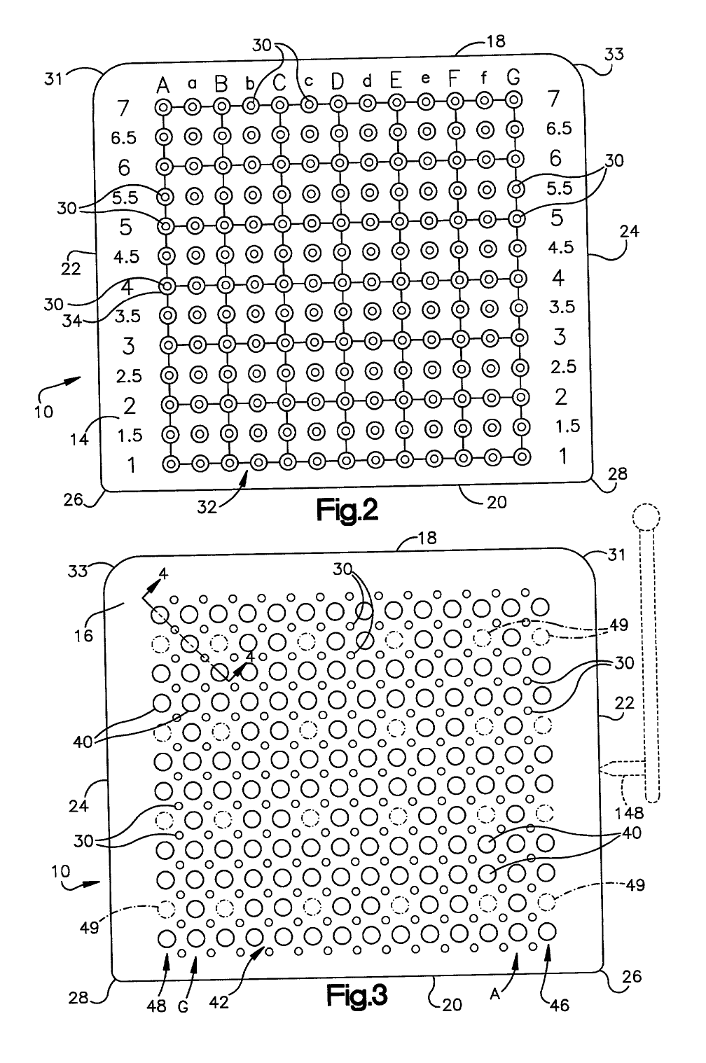

The present invention relates to a method of injection molding an article having an array of openings, and to an article made by such process. In particular, the present invention relates to a method of injection molding a template for use in radiation therapy. As representative of the present invention, FIGS. 1-4 illustrate an article 10 made by a process in accordance with the present invention.

The article 10 in the illustrated embodiment is a template for use in brachytherapy. The template 10 is usable in accordance with the above-identified U.S. Pat. Nos. 6,129,670 and 6,256,529. The template 10 has a rectangular, block-shaped configuration. The template is injection molded from a plastic material 12, as described below.

The template 10 has opposite front and back surfaces 14 and 16 each having a generally rectangular, almost square configuration. Four generally rectangular side surfaces of the template 10 extend between and interconnect the front and back surfaces 14 and 16. The side surfaces include an upper (as viewed in FIGS. 1-3) side surface 18, a lower side surface 20, and left and right side surfaces 22 and 24, respectively.

The template 10 as thus formed has four side corners 26, 28, 31 and 33. The upper corners 31 and 33 are rounded off. In the illustrated embodiment, the template 10 has a height of about 2.8 inches, a width of about 3.19 inches, and a thickness of about 0.75 inches. The invention is not limited to the molding of articles of any particular size or configuration.

The template 10 is preferably molded from a low viscosity and low shrinkage thermoplastic material 12, such as LCP. This material selection provides significant advantages in the molding process, as described below.

The template 10 is provided with two mounting openings (not shown) in the lower side surface 20. In each mounting opening there is located an internally threaded metal insert (not shown). The inserts are adapted to receive externally threaded mounting members (not shown) for supporting the template 10 in position for usage in a brachytherapy procedure.

The template 10 has a plurality or group or array of cylindrical needle openings 30. The needle openings 30, as a group, are identified in the drawings with the reference numeral 32. The needle openings 30 are working openings, that is, are needed for the functioning of the article 10 in its intended environment. The needle openings 30 are adapted to receive brachytherapy needles, or catheters, in a known manner.

In addition to the needle openings 30, the template has a plurality or group of cylindrical core openings 40 (FIGS. 40). The core openings 40, as a group, are identified in the drawings with the reference numeral 42. The core openings 40 are interspersed with the needle openings 30. The core openings 40 are not working openings, that is, are not strictly needed for the functioning of the article 10 in its intended environment. The core openings 40 function to reduce plastic material usage and reduce molding cycle time. The invention is not limited to a specific number or array of core openings.

The needle openings 30 extend completely through the template 10 between the front and back surfaces 14 and 16. Thus, the needle openings 30 are visible from both the front surface 14 and the back surface 16 of the template 10.

The needle openings 30 extend parallel to each other and parallel to the side surfaces 18-24 of the template 10. Thus, the needle openings 30 extend perpendicular to the front and back surfaces 14 and 16 of the template 10.

The needle openings 30 are arranged in a grid or array. In the illustrated embodiment, the array 32 of needle openings 30 has a rectangular, specifically square, configuration. It should be understood that an article made in accordance with the invention could have an array of openings with a different configuration, other than rectangular or square. In the illustrated embodiment, the needle openings 30 are arranged in a regular pattern in a 13×13 array 32, about 2.4 inches square.

The needle openings 30 are equally spaced in the array 32 along horizontal and vertical lines shown in dot-dash format in FIG. 5, to form rows and columns. Thus, any four adjacent needle openings 30 form a small square between them. In addition, the needle openings 30 line up also along diagonals shown in dot-dash form in FIG. 5.

The rows and columns of needle openings 30 are individually labeled, on the front surface 14 of the template 10. The rows of needle openings 30 are labeled with numbers. There are thirteen rows, labeled (from bottom to top) “1”, “1.5”, “2”, “2.5”, “3”, “3.5”, “4”, “4.5”, “5”, “5.5”, “6”, “6.5” and “7”. Each row of needle openings 30 has thirteen openings 30.

The columns of needle openings 30 are labeled with letters. There are thirteen columns, labeled (from left to right) “A”, “a”, “B”, “b”, “C”, “c”, “D”, “d”, “E”, “e”, “F”, “f” and “G”. Each column of needle openings 30 has thirteen openings 30.

By virtue of this labeling system, each one of the needle openings 30 may be identified, and distinguished from the other needle openings 30, by a number-letter identification. For example, the left-uppermost needle opening 30 can be identified by number-letter combination “7A”, while the needle opening 30 in the fourth row down and the fourth column over from the left can be identified by the number-letter combination “5.5b”. This identification system is used to place the brachytherapy needles (not shown) in the proper location.

The needle openings 30 are a certain, predetermined size (diameter). This ensures that the needle openings 30 are adapted to receive brachytherapy needles as noted in the above-identified U.S. Pat. Nos. 6,129,670 and 6,256,529.

Specifically, in the illustrated embodiment, the needle openings 30 have a diameter of 0.0519 inches. This size opening is adapted to receive an 18 gauge brachytherapy needle having a diameter of 0.049-0.050 inches. This particular diameter for the needle openings 30 is selected in a manner and for a reason described below. Again, the invention is not limited to any particular size of needle opening 30.

As noted above, the needle openings 30 extend completely through the template 10, from the front surface 14 to the back surface 16. As a result, the needle openings 30 have a length of about 19 millimeters, which is equal to the thickness of the template 10.

The center to center spacing between adjacent needle openings 10 in a row or column is 0.197 inches (½ cm). The center to center spacing between diagonally adjacent needle openings 30 is about 0.279 inches, which is 0.197 inches times the square root of two. The invention is not limited to needle opening spacing of any particular dimension.

Each one of the needle openings 30 is provided with a lead-in 34 (FIGS. 1 and 4) of 82 degrees tapering out to 0.114 inch diameter on the front surface 14 of the template 10. The lead-in 34 is a tapered surface that extends between the front surface 14 of the template 10 and the cylindrical surface 36 that defines the needle opening 30. The lead-in 34 facilitates the insertion of a brachytherapy needle into the needle opening 30 from the direction of the front surface 14.

The core openings 40 extend only partially through the template 10 from the back surface 16, as can best be seen in FIG. 4. Thus, the core openings 40 are visible only from the back surface 16 of the template 10.

The core openings 40 extend parallel to each other and to the needle openings 30. The core openings 40 are arranged in a grid or array 42. The array 42 is generally rectangular in configuration, similar to the array 32 of needle openings 30.

The core openings 40 in the particular embodiment illustrated in the drawings are arranged overall in a regular pattern in a 14×12 array 42. Most of the core openings 40 are located between the needle openings 30. Specifically, most of the core openings 40 are located at the intersection of diagonals in each small square formed by the needle openings 30 (that is, is located at the center of the small square).

For example, the core opening 40a (FIG. 5) is located at the intersection of the diagonals in the small square 44 formed by the needle openings 30a, and is located at the center of that small square. The spacing between adjacent core openings 40 is the same as that between adjacent needle openings 30. Thus, the core openings 40 are interspersed in a regular pattern with the needle openings 30. The spacing could, however, be different.

Some of the core openings 40 are not located between the needle openings 30. Specifically, some of the core openings 40 are located outside of the array 32 of needle openings, either in a direction toward the left side surface 22 or a direction toward the right side surface 24. For example, one column 46 (FIG. 3) of eight core openings 40 is located to the right (as viewed from the back surface 16 of the template 10) of the last column of needle openings 30, the column “A”. Another column 48 of eight core openings 40 is located to the left (as viewed from the back surface 16 of the template 10) of the first column of needle openings 30, the column “G”.

The array 42 of core openings 40 is “incomplete”—that is, at some of the locations in the 14×12 array, core openings 40 are not formed. Thus, molded material 12 is present that may be engaged by ejector pins to remove the template 10 after molding. The placement and use of the ejector pins is described below.

When the template 10 is completed, witness lines 49 (FIG. 3) may be left in the back surface 24 of the template, at the location of the ejector pins. There are four rows of six ejector pin locations, spaced fairly equally about the back surface 24 to enable correct removal of the template after molding. It should be understood that the ejector pins could be placed elsewhere than at the location of places in the array 42.

The diameter of the core openings 40 is selected to remove (“core”) as much material 12 as is possible from the template 10, between the needle openings 30, while still maintaining the structural integrity of the template. Removing the material 12 lowers the finished weight of the template 10, also provides a more uniform thickness to the template to promote cooling in a desired manner after molding, reduces material usage, and shortens cycle time.

The core openings 40 are larger in diameter than the needle openings 30. Specifically, in the illustrated embodiment, the core openings 40 have a diameter of 0.1875 inches. This is about 350% of the diameter of the needle openings 30.

The core openings 40 could, however, have a different diameter. The core openings 40 could be as small as the needle openings 30, or smaller.

In accordance with a feature of the invention, the core openings 40 are made with standard D-M-E pins, as described below. The core pins are available from D-M-E (formerly Detroit Mold Engineering) of Madison Heights, Mich. D-M-E pins are the

A front surface 66 of the first mold half 52 extends parallel to but is recessed inward from the parting surface 64. An edge surface 68 extends between and interconnects the front surface 66 and the parting surface 64. The front surface 66 and the edge surface 68 define a recess 70 in the first mold half 52. The recess 70 forms a part of the mold cavity 60 when the mold 50 is closed as described below.

The first mold half 52 includes a plurality of conical projections 72 on the front surface 66. The conical projections 72 have the reverse configuration of the lead-ins 34 on the front surface 14 of the template 10. The projections 72 are located in the recess 70.

The recess 70, and the conical projections 72, are formed by electric discharge machining of the body portion 62 of the first mold half 52. A shaped carbon electrode 74 (shown in dashed lines in FIG. 9) is provided having the configuration of the front surface 12 of the template 10, minus the needle openings 30. The carbon electrode 74 is engaged with the main body portion 62 of the first mold half 52 and burns away a part of it, leaving the recess 70. The conical projections 72 remain. When the burning (machining) process is completed, passages 76 are drilled in the body portion 62 of the first mold half 52, one extending passage through each one of the conical projections 72.

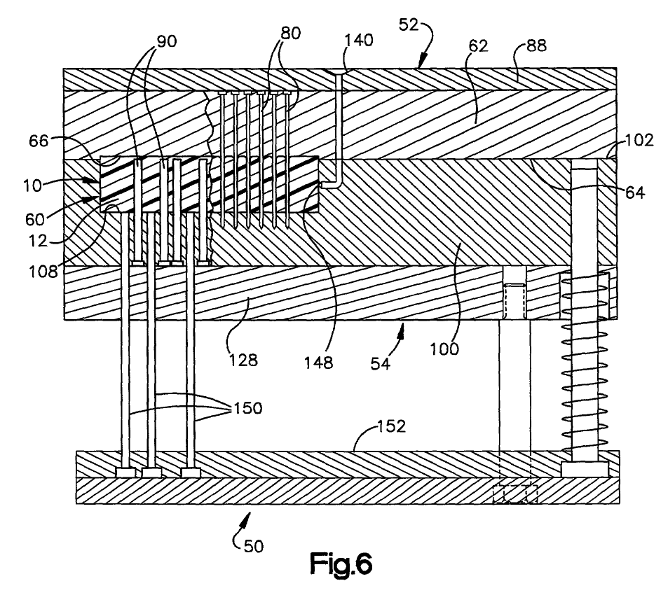

The first mold half 52 includes a plurality, or array, of needle pins. The needle pins are individually numbered 80 in FIGS. 6-9, and are numbered as a group 82.

Each one of the needle pins 80 has a head portion 84 that is received in a recess in the body portion 62 of the first mold half 52. A clamp plate 88 engages the head portions 84 of the needle pins 80 and secures the needle pins to the body portion 62. Each one of the needle pins 80 has a shank portion 90 that projects from the head portion 84. The shank portion 90 is relatively thin, that is, relatively small in diameter.

The shank portion 90 of each needle pin 80 has a first section 92 that extends through one of the passages 76 in the body portion 62 of the first mold half 52. The shank portion 90 of each needle pin 80 has a constant diameter second section 94 that projects from one of the conical projections 72 on the front surface 66 and into the mold cavity 60, in a direction toward the second mold half 54.

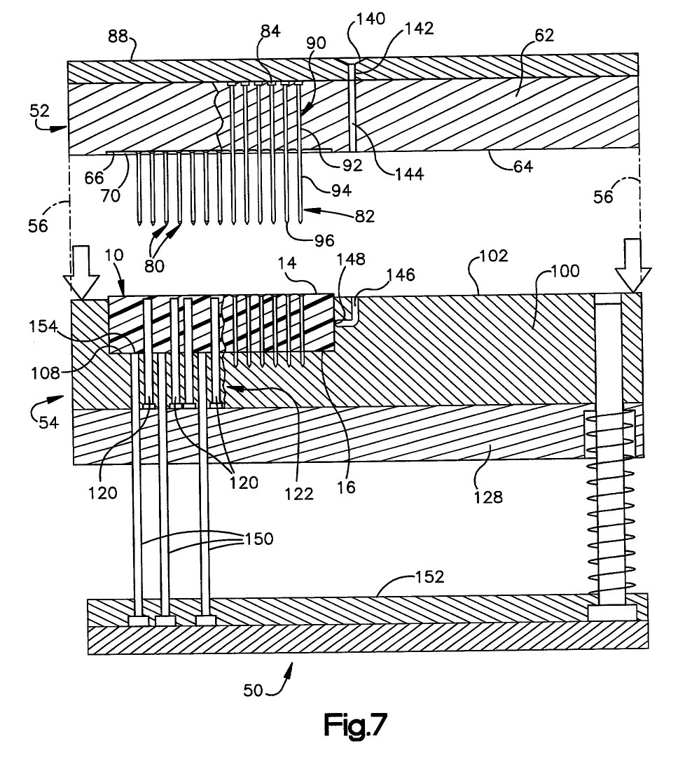

The needle pins 80 are long enough so that they extend completely through, and beyond, the mold cavity 60, when the mold 50 is in the closed condition shown in FIG. 6. Each one of the needle pins 80 has a tapered end portion 96 (FIG. 7) for engagement with the second mold half 54, as described below.

The needle pins 80 all extend parallel to one another other and parallel to the axis 56. The group 82 of needle pins 80 are arranged in a grid or array that has the same pattern as the needle openings 30 in the template 10 to be molded. The needle pins 80 are of the same number, and have the same diameter, as the needle openings 30 in the article 10 to be molded.

The second mold half 54 includes a body portion 100 that is preferably made from the same material as the body portion 62 of the first mold half 52. The body portion 100 has a parting surface 102 for mating with the parting surface 64 of the first mold half 52.

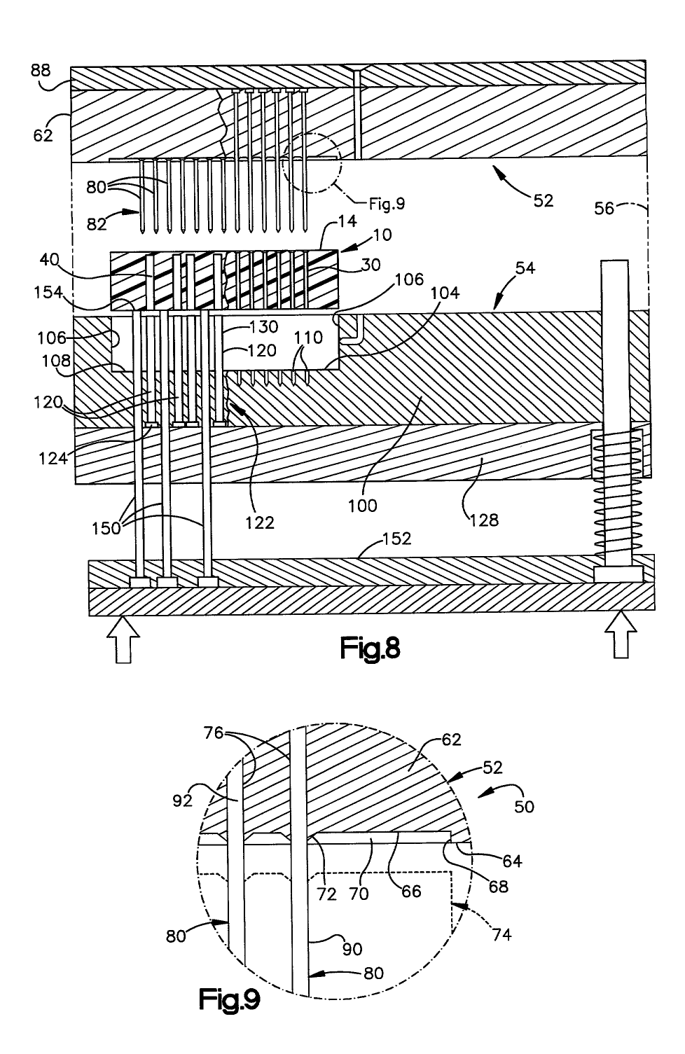

The second mold half 54 includes an outer surface 104 that partially defines the mold cavity 60 when the mold 50 is in the closed condition shown in FIG. 6. In the illustrated embodiment, the outer surface 104 includes four side surfaces 106 (two of which are shown in FIG. 8) and a back surface 108. The back surface 108 on the second mold half 54 extends parallel to and is presented toward the front surface 66 on the first mold half 52. The side surfaces 106 extend normal to the back surface 108, and parallel to the axis 56.

The second mold half 54 includes a plurality of pin end recesses 110 that extend inward from the back surface 108 in a direction away from the first mold half 52. The configuration of the pin end recesses 110 is adapted to receive the tapered end portions 96 of the needle pins 80.

The second mold half 54 includes a plurality or array of core pins that are numbered individually 120 in FIGS. 6-9. The core pins 120 are numbered as a group 122.

Each one of the core pins 120 has a head portion 124 that is received in a recess in the body portion 100 of the second mold half 54. A clamp plate 128 engages the head portions 124 of the core pins 120 and secures the core pins to the body portion 100.

Each one of the core pins 120 has a shank portion 130 that projects from the head portion 124 through a respective passage in the body portion 100 of the second mold half 54. The shank portions 130 of the core pins 130 are relatively thick, that is, relatively large in diameter, compared to the shank portions 90 of the needle pins 80.

The shank portion 130 of each core pin 120 has a first section that is enclosed within the body portion 100 of the second mold half 54. The shank portion 130 of each core pin has a constant diameter second section that projects from the back surface 108 of the second mold half 54 and into the mold cavity 60, in a direction toward the first mold half 52.

The core pins 120 all extend parallel to one another other and parallel to the axis 56. The core pins 120 are arranged in a grid or array that has the same pattern as the core openings 40 in the template 10 to be molded. The core pins 120 are of the same number, and have the same diameter, as the core openings 40 in the article 10 to be molded.

Thus, the core pins 120 are relatively thick compared to the needle pins 80. Specifically, in the illustrated embodiment, the core pins 120 have a diameter of 0.1875 inches. This is a standard D-M-E pin size, as described above. This is about 350% of the diameter of the needle pins 80. The core pins 120 could, however, have a different diameter, larger than or smaller than the needle pins 80.

The length of the core pins 120 is selected so that the core pins do not extend completely through the mold cavity 60 when the mold 50 is in the closed condition shown in FIG. 6. As a result, the core pins 120 terminate short of the front surface 66 of the first mold half 52. Therefore, when the template 10 is molded, the core openings 40 do not extend completely through the template from the front surface 14 to the back surface 16.

The mold assembly 50 includes a sprue bushing 140 in the clamp plate 88 for the first mold half 52. The sprue bushing 140 is connected in fluid communication with a runner 142 in the clamp plate 88 and a runner 144 in the body portion 62 of the first mold half 52. When the mold 50 is in the closed condition, the runner 144 is connected in fluid communication with a runner 146 in the body portion 100 of the second mold half 54. The runner 146 terminates in a gate 148 for directing the melt into the mold cavity 60. The gate 148 is located in one of the side surfaces 106 of the second mold half 54.

The location of the gate 148 relative to the mold cavity 60 is selected to be near one or two of the core pins 120 when the mold 50 is in the closed condition shown in FIG. 6, as described below. Molten plastic material 12 can be supplied to the gate 148 through the sprue bushing 140 and the runners 142-146, in a known manner.

The molding apparatus includes a plurality of ejector pins 150 for ejecting the finished template 10 from the mold 50. The ejector pins 150 are secured to an ejector plate 152. The ejector plate 152 is movable relative to the second mold half 54, in a known manner, to cause the ejector pins 150 to move relative to the second mold half.

The ejector pins 150 have flat end surfaces 154 that extend parallel to the back surface 108 on the second mold half 54. The length of the ejector pins 150 is selected cavity 60. Therefore, when the template 10 is molded, the ejector pins 150 are substantially aligned with the back surface 16 of the template 10.

The template 10 is molded as follows. The first and second mold halves 52 and 54 are moved relative to each other, from the open condition shown in FIG. 7 to the closed condition shown in FIG. 6. (FIG. 7 shows the mold in an open condition with a molded part 10 already present; the molding process would start without a part in the mold 50.)

When the two mold halves 52 and 54 are brought together as shown in FIG. 6, the parting surface 102 of the second mold half 54 engages the parting surface 64 of by the first mold half 52. The mold cavity 60 is defined in the mold 50, between the front surface 66 and edge surface 68 on the first mold half 52, and the back surface 108 and side surfaces 106 on the second mold half 54.

The recess 70 in the first mold half 52 aligns with the mold cavity portion in the second mold half 53, together forming the mold cavity 60. The needle pins 80 of the first mold half 52 extend completely through the mold cavity 60, from the front surface 66 on the first mold half to the back surface 108 on the second mold half 54.

The tapered end portions 96 of the needle pins 80 engage in the recesses 110 in the back surface 108 on the second mold half 54. This engagement prevents lateral movement of the end portions 96 of the needle pins 80. This helps to prevent the needle pins 80 from bending or otherwise deforming during the molding operation, as described below. needle pins 80 from bending or otherwise deforming during the molding operation, as described below.

When the mold 50 is in the closed condition, the core pins 120 extend from the back surface 108 on the second mold half 54, into the mold cavity 60. The core pins 120 do not extend completely through the mold cavity 60, but terminate short of the front surface 66 of the first mold half 52. The molding machine that includes the mold assembly 50 has other features not shown, such as one or more vents, clamps, etc, used to operate the mold assembly 50 in a known manner.

The molten material 12 is conducted into the mold cavity 60 through the sprue bushing 140, the runners 142-146, and the gate 148. When the material 12 enters the mold cavity 60 through the gate 148, the flow of material first engages one or more of the core pin(s) 120, such as core pins in the column 46 (FIG. 3) of core openings 40, in which the gate 148 is shown schematically. The engagement of the material 12 with the core pin(s) 120 deflects the flow of molten material into the mold cavity 60 before the molten material engages the needle pins 80. Because the core pins 120 are significantly thicker (larger in diameter) than the needle pins 80, the core pins 120 are stronger and better able to withstand the force of the molten plastic 12 being injected into the mold cavity 60. The presence of the core pins 120 adjacent the gate 148 thus helps to minimize stresses on the needle pins 80 in the mold cavity 60.

As the material 12 fills the mold cavity 60, it flows around and encloses the second section 94 of each one of the needle pins 80. The material 12 also flows around and encloses the shank portions 130 of the core pins 120. The material 12 also engages the end surfaces 154 of the ejector pins 150.

When the template 10 is, thereafter, cooled, and the thermoplastic material has solidified, the mold 50 is opened. As the mold 50 is opened, the movement of the second mold 54 half toward the ejector plate 152 causes the ejector pins 150 to apply force to the back surface 16 of the template 10. This force helps to remove the template 10 from the mold cavity 60.

The completed (molded) template 10 includes the array 32 of needle openings 30 that result from the presence of the needle pins 80 in the mold cavity 60 during molding. The needle openings 30 extend completely through the template 10, between the front surface 14 and the back surface 16 of the template.

The completed template 10 also includes the array 42 of core openings 40 that result from the presence of the core pins 120 in the mold cavity 60 during molding. The core openings 40 do not extend completely through the template 10, but instead terminate short of the front surface 14 of the template. The completed template 10 also includes witness lines 49 where the ejector pins 150 engaged the plastic material 12 during molding.

As noted above, the template 10 is preferably molded from a low viscosity and low shrinkage thermoplastic material 12, such as LCP (liquid crystal polymer). This material selection provides significant advantages in the molding process.

Specifically, LCP when molten has a low viscosity and thus flows easily in the mold cavity. This low viscosity helps to decrease the amount of force with which the plastic material 12 impacts the needle pins 80 during the injection of the material 12 into the mold cavity 60. This reduction in force helps to enable the use of the very small diameter needle pins 80.

Also, LCP has low shrinkage around the needle pins 80 and the core pins 120. This low shrinkage rate minimizes the chance that the molded part 10 will adhere to the needle pins 80 or to the core pins 120, enabling easy release of the molded part from the pins.

In addition, the molding process is preferably run with high temperature settings and long cooling times. Specifically, the molding process is run at the higher end of the range of recommended temperature settings for the selected material 12. This temperature setting contributes to lowering the viscosity of the material 12 in the mold cavity 60, which is advantageous as described above. One preferred temperature is 685 to 725 degrees Fahrenheit. The long cooling times also help to keep the needle openings 30 uniform during injection and during ejection from the mold 60. One preferred cooling time is about 70 seconds.

A presently preferred material 12 for the article (template) 10 is DuPont® Zenite® liquid crystal polymer resin. This material is available from E. I. DuPont de Nemours & Col of Wilmington, Del. Other LCP or similar thermoplastic materials with required properties may, of course, be suitable.

Having described the invention, I claim:

1. A method of injection molding an article having first and second surfaces on opposite sides of the article, a first array of first openings that extend completely through the article between the first and second surfaces, and a second array of second openings that extend only partially through the article from the second surface in a direction toward the first surface and that are interspersed with first openings of the first array, said method comprising the steps of:
providing a mold defining a mold cavity having a configuration corresponding to the configuration of the article, the mold having a first array of first pins extending through the mold cavity between first and second inner surfaces of the mold having a configuration corresponding to the configuration of the first and second surfaces of the article, the mold also having a second array of second pins extending only partially through the mold cavity from the second inner mold surface in a direction toward the first inner mold surface; and
conducting a flow of molten material into the mold cavity when the mold is in a closed condition to flow around the first pins to form the first openings in the article and to flow around the second pins to form the second openings in the article.

2. A method as set forth in claim 1 wherein said step of providing a mold includes selecting the first pins for use in the mold from a set of standard pins that are available for purchase in standard diameters, the selected first pins having a diameter that is greater than the diameter needed for the first openings in the article.

3. A method as set forth in claim 2 wherein said step of providing a mold includes selecting the second pins for use in the mold from a set of standard pins that are available for purchase in standard diameters, the selected second pins having a diameter that is selected to create second openings in the article that are as large as feasible to remove as much material as possible from the article to reduce material usage and improve molding cycle time without compromising article strength.

4. A method as set forth in claim 1 wherein said step of conducting a flow of molten material includes conducting a flow of a low viscosity and low shrinkage thermoplastic material.

5. A method as set forth in claim 4 wherein said step of conducting a flow of thermoplastic material includes conducting a flow of molten liquid crystal polymer material.

6. A method as set forth in claim 5 wherein said step of conducting a flow of molten liquid crystal polymer material includes conducting a flow of a material at a temperature in the range of 685 to 725 degrees Fahrenheit.

7. A method as set forth in claim 6 further including the step of cooling the molten material in the mold for a period of time of about 70 seconds.

8. A method as set forth in claim 1 wherein said step of providing a mold includes selecting the first pins for use in the mold from a set of standard pins that are available for purchase in standard diameters, the selected first pins having a diameter that is greater than the diameter needed for the first openings in the article, and wherein said step of conducting a flow of molten material includes conducting a flow of a low viscosity and low shrinkage thermoplastic material.

9. A method as set forth in claim 8 wherein said step of providing a mold includes selecting the second pins for use in the mold from a set of standard pins that are available for purchase in standard diameters, the selected second pins having a diameter that is selected to create second openings in the article that are as large as feasible to remove as much material as possible from the article to reduce material usage and improve molding cycle time without compromising article strength, and wherein said step of conducting a flow of thermoplastic material includes conducting a flow of molten liquid crystal polymer material.

10. A method as set forth in claim 1 wherein said step of providing a mold includes making the first inner surface of the mold by electric discharge machining of a mold body, said step of electric discharge machining including forming an array of projecting tapered portions of the first inner surface, each one of the projecting tapered portions having a first pin extending through the projecting tapered portion.

11. A method as set forth in claim 1 wherein the second pins are relatively thick compared to the first pins, and wherein said step of conducting a flow of molten material into the mold cavity includes deflecting the flow of molten material with the relatively thick second pins prior to engaging the relatively thin first pins with the flow of molten material to minimize stresses on the first pins in the mold cavity.

12. A method as set forth in claim 11 wherein said deflecting step includes deflecting the flow of molten material with second pins that have a diameter that is in the range of from about 150% to about 500% of the diameter of the first pins.

13. A method as set forth in claim 1 further including the steps of:
providing a plurality of ejector pins having end surfaces that extend from a location outside of the mold cavity and that have end surfaces substantially aligned with the second inner surface of the mold when the mold is in the closed condition; and
moving the ejector pins relative to the mold cavity to remove the molded article from the mold cavity when the mold is in an open condition.

14. A method as set forth in claim 13 wherein said step of providing an array of relatively thick pins includes providing an incomplete array of relatively thick pins, the incomplete array defining locations at which second openings are not formed in the article and at which the end surfaces of the ejector pins are engageable with the article during said step of moving the ejector pins relative to the mold cavity to remove the molded article from the mold cavity.

15. A method as set forth in claim 1 wherein said step of providing a mold includes providing a two part mold including a first mold part having a first one of the inner surfaces of the mold from which the array of relatively thin first pins extend through the mold cavity and a second mold part having a second one of the inner surfaces of the mold from which the relatively thick second pins extend into the mold cavity;
said method further including the step of closing the mold prior to conducting a flow of molten material into the mold cavity, said closing step including moving the first and second mold parts relative to each other to intersperse the relatively thick first pins with the relatively thin second pins.

16. A mold assembly for injection molding an article having first and second surfaces on opposite sides of the article, a first array of pin openings that extend completely through the article between the first and second surfaces, and a second array of core openings that extend only partially through the article from the second surface in a direction toward the first surface and that are interspersed with pin openings of the first array, said mold assembly comprising:
a first mold part and a second mold part movable between an open condition of said mold assembly and a closed condition of said mold assembly, said first and second mold parts defining a mold cavity having a configuration corresponding to the configuration of the article;
said first mold part having a first inner surface of the mold having a configuration corresponding to the configuration of the first surface of the article;
said first mold part having a first array of first pins extending from the first inner surface through the mold cavity when said mold assembly is in the closed condition;
said second mold part having a second inner surface of the mold having a configuration corresponding to the configuration of the second surface of the article;
said second mold part having a second array of second pins extending from the second inner surface and only partially into the mold cavity.

17. A mold assembly as set forth in claim 16 wherein said first pins are selected from a set of standard pins that are available for purchase in standard diameters, the selected first pins having a diameter that is greater than the diameter needed for the first openings in the article.

18. A mold assembly as set forth in claim 17 wherein said second pins are selected from a set of standard pins that are available for purchase in standard diameters, the selected second pins having a diameter that is selected to create second openings in the article that are as large as feasible to remove as much material as possible from the article to reduce material usage and improve molding cycle time without compromising article strength.

19. A mold assembly as set forth in claim 16 wherein said first inner surface of said first mold part has an array of projecting tapered portions, each one of said projecting tapered portions having a respective first pin extending through said projecting tapered portion.

20. A mold assembly as set forth in claim 16 wherein each one of said first pins is spaced apart from each one of said second pins when said mold assembly is in the closed condition.

21. A mold assembly as set forth in claim 20 wherein said first pins are arranged in rows and columns and said second pins are arranged in rows and columns interspersed between the rows and columns of said first pins.

22. A mold assembly as set forth in claim 21 wherein said second pins are coring pins that are relatively thick compared to said second pins.

23. A mold assembly as set forth in claim 22 wherein said coring pins have a diameter that is in the range of from about 150% to about 500% of the diameter of said first pins.

24. A mold assembly as set forth in claim 16 wherein said second pins are relatively thick compared to said first pins, and wherein said mold assembly includes a gate for conducting a flow of molten material into said mold cavity, at least one of said second pins being located in said mold cavity adjacent said gate to deflect the flow of molten material prior to said flow engaging said relatively thin first pins to minimize stresses on said first pins in said mold cavity.
